(19) United States
(12) Patent Application Publication
(10) Pub. No.: US 2009/0148088 A1
(43) Pub. Date: Jun. 11, 2009

(54) Lubricator for Rolling Bearings

(76) Inventors: Mitsuo Sasabe, Mie (JP); Masatsugu Mori, Mie (JP)

Correspondence Address: WENDEROTH, LIND & PONACK, L.L.P., 1030 15th Street, N.W.,, Suite 400 East, Washington, DC, 20005-1503, US

(21) Appl. No.: 11/988,431

(22) PCT Filed: Jul. 19, 2006
(86) PCT No.: PCT/JP2006/314239

§ 371 Date: Jan. 8, 2008

(30) Foreign Application Priority Data
Jul. 20, 2005 (JP) 2005-210119

(51) Int. Cl. F16C 33/66; F16C 37/00

(52) U.S. Cl. 384/467

(57) ABSTRACT

The object is to provide a lubricator for rolling bearings which is also capable of cooling the inner ring and which can reduce the resistance of cooling oil when the oil is agitated during high-speed rotation of the bearing.

On the back side of an angular ball bearing 1, a cooling oil introducing member 11 is provided which includes a nozzle 12 for discharging cooling oil toward a circumferential groove 6 formed in an end surface of an inner ring 2. The cooling oil introducing member 11 has an extension 11a formed with a seal portion 13 that faces a tapered surface 2b of the inner ring with a gap δ left therebetween. The gap δ of the seal portion is set at 0.2 mm or less to limit the amount of cooling oil that flows through the seal portion 13 into the bearing to a minimum, thereby reducing the resistance of cooling oil when the oil is agitated during high-speed rotation of the angular ball bearing 1.

### TECHNICAL FIELD

The present invention relates to a lubricator for rolling bearings which is also capable of cooling an inner ring of a bearing.

### BACKGROUND ART

When a rolling bearing is used to support a rotary shaft rotating at a high speed such as a spindle of a machine tool, the inner ring is heated to a higher temperature than the outer ring due e.g. to machining loads. Due to this temperature difference, the inner and outer rings expand to different degrees, thus excessively increasing the preload applied to the bearing. This in turn shortens the lifespan of the bearing.

In order to cope with this problem, lubricators for rolling bearings are known (see e.g. Patent document 1) which are configured to discharge cooling oil supplied from a cooling oil feeder toward the inner rotary ring of a rolling bearing from one end of the bearing, and have a seal portion facing the radially outer surface of the inner ring at one end thereof toward which cooling oil is discharged, with a gap left between the seal portion and the radially outer surface of the inner ring, whereby the cooling oil discharged toward the one end of the inner ring partially flows through the gap into the bearing as lubricating oil. Such a lubricator can also cool the inner ring, thus eliminating the need for a separate cooling device.

Patent document 1: JP Patent Publication 2004-360828A (FIGS. 5 to 7

### DISCLOSURE OF THE INVENTION

### Object of the Invention

With the lubricator for rolling bearings disclosed in Patent document 1, the amount of cooling oil that flows into the bearing as lubricating oil increases with an increase in the gap between the radially outer surface of the inner ring and the seal portion. In the case of a rolling bearing supporting a rotary shaft that rotates at a high speed of 10000 rpm or over, such as a spindle of a machine tool, the larger the amount of cooling oil that flows into the bearing, the higher the resistance of cooling oil when the oil is agitated during high-speed rotation of the rolling bearing. This increases the power loss.

An object of the present invention is to provide a lubricator for rolling bearings which is also capable of cooling the inner ring and which can reduce the resistance of cooling oil when the oil is agitated during high-speed rotation of the bearing.

### Means to Achieve the Object

In order to achieve this object, the present invention provides a lubricator for a rolling bearing, the lubricator being configured to discharge cooling oil supplied from a cooling oil feeder toward an inner rotary ring of the rolling bearing from one axial end of the bearing, and having a seal portion facing a radially outer surface of the inner ring at one end thereof toward which cooling oil is discharged, with a gap left between the seal portion and the radially outer surface of the inner ring, whereby the cooling oil discharged toward the one end of the inner ring partially flows through the gap into the interior of the bearing as lubricating oil, characterized in that the gap is not more than 0.2 mm.

The present inventors measured the amount Q of cooling oil that flows through the gap δ between the radially outer surface of the inner ring and the seal portion when the gap δ is changed. As a result, as shown in FIG. 4, it was discovered that while the gap δ is 0.2 mm or less, the amount Q was small and remained substantially unchanged, and when the gap δ exceeded 0.2 mm, the amount Q began to increase sharply. Based on these measurement results, the gap between the radially outer surface of the inner ring and the seal portion was set at 0.2 mm or less, so that it is possible to stably suppress the amount of cooling oil flowing into the bearing, thereby reducing the resistance of cooling oil when the oil is agitated during high-speed rotation of the bearing.

The present invention also provides a lubricator for a rolling bearing, the lubricator being configured to discharge cooling oil supplied from a cooling oil feeder toward an inner rotary ring of the rolling bearing from one end of the bearing, and having a seal portion facing a radially outer surface of the inner ring at one axial end thereof toward which cooling oil is discharged, with a gap left between the seal portion and the radially outer surface of the inner ring, whereby the cooling oil discharged toward the one end of the inner ring partially flows through the gap into the interior of the bearing as lubricating oil, characterized in that the seal portion is formed with a circumferential oil groove in a radially inner surface thereof that faces the radially outer surface of the inner ring.

By forming a circumferential oil groove in a radially inner surface of the seal portion facing the radially outer surface of the inner ring, it is possible to improve sealability, thereby stably suppressing the amount of cooling oil flowing into the bearing, which in turn makes it possible to reduce the resistance of cooling oil when the oil is agitated during high-speed rotation of the bearing.

### Advantages of the Invention

With the lubricator for rolling bearings according to the present invention, since the gap between the radially outer surface of the inner ring and the seal portion is set at 0.2 mm or less, it is possible to stably suppress the amount of cooling oil flowing into the bearing, thereby reducing the resistance of cooling oil when the oil is agitated during high-speed rotation of the bearing.

Also, with the lubricator for rolling bearings according to the present invention, by forming a circumferential oil groove in a radially inner surface of the seal portion facing the radially outer surface of the inner ring, it is possible to improve sealability, thereby stably suppressing the amount of cooling oil flowing into the bearing, which in turn makes it possible to reduce the resistance of cooling oil when the oil is agitated during high-speed rotation of the bearing.

### BRIEF DESCRIPTION OF THE DRAWINGS

FIG. 1 is a structural view showing a spindle assembly including a lubricator for rolling bearings according to the present invention, and a cooling oil feeder connected thereto.

FIG. 2 is an enlarged sectional view of a portion A of the lubricator in FIG. 1.

FIG. 3 is an enlarged sectional view of a portion B of the lubricator in FIG. 1.

FIG. 4 is a graph showing the results of measurement of the relationship between the gap δ at the seal portion and the amount Q of cooling oil that flows into the bearing.

### DESCRIPTION OF NUMERALS

1. Angular ball bearing
2. Inner ring
3. Outer ring
2a, 3a. Raceway
2b. Tapered surface
3b. Counterbore
4. Ball
5. Retainer
6. Circumferential groove
11. Cooling oil introducing member
11a. Extension
11b. Inlet hole
11c. Discharge hole
11d. Discharge groove
11e. Communicating hole
12. Nozzle
13. Seal portion
14a, 14b. Oil storage space
15. Lid member
16. Oil groove
20. Spindle
21. Bearing housing unit
21a. Inner bearing housing
21b. Outer bearing housing
22. Inner ring spacer
23. Inner ring presser
24. Outer ring spacer
25. Outer ring presser
30. Cooling oil feeder
31. Cooling oil circulation passage
32. Feed passage
32a. Branched feed passage
33. Return passage
34a. Inlet hole
34b. Discharge hole
35. Pressure regulating valve
36. Oil filter
37. Inlet hole
38. Oil collecting passage
39. Oil pump
40a, 40b. Discharge hole

### BEST MODE FOR EMBODYING THE INVENTION

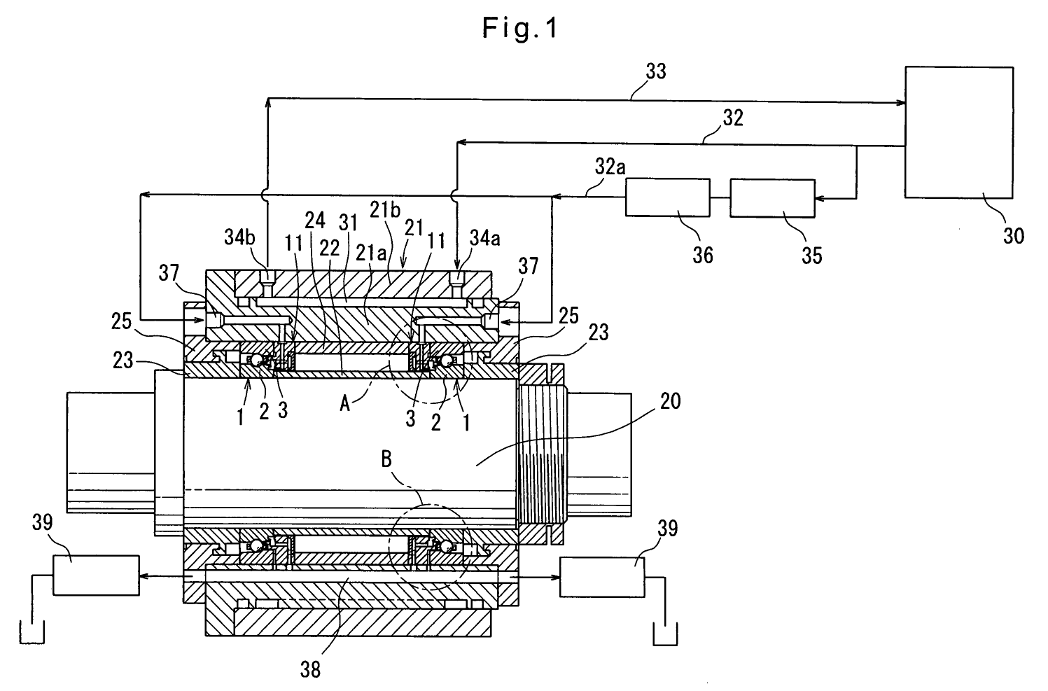

Now referring to the drawings, the embodiment of the present invention is described. FIG. 1 shows a spindle assembly for a machine tool which includes a lubricator for bearings according to the present invention. The spindle assembly includes a spindle 20 carrying at its end a chuck for a tool or a workpiece, and driven by a motor (not shown). The spindle 20 is supported by two rolling bearings in the form of angular ball bearings 1 that are mounted in a bearing housing unit 21 so as to be axially spaced from each other. To the spindle assembly, a cooling oil feeder 30 is connected which feeds cooling oil for cooling the bearing housing unit 21 and inner rings 2 of the angular ball bearings 1, as will be described below.

As shown in FIG. 2, the angular ball bearings 1 each comprise inner and outer rings 2 and 3 formed with raceways 2a and 3a, respectively, balls 4 received between the raceways 2a and 3a, and a retainer 5 retaining the balls 4 in position. The outer ring 3 is formed with a counterbore 3b on its inner periphery on the front side of the bearing, where axial loads are applied to the inner ring 2. The inner ring 2 is formed with a tapered surface of which the diameter increases toward the raceway 2a on its outer periphery on the back side of the bearing. In the end surface of the inner ring 2 on the back side of the bearing, a circumferential groove 6 is formed.

As shown in FIG. 1, the bearing housing unit 21 has a double wall structure comprising an inner housing 21a and an outer housing 21b. The inner rings 2 of the angular ball bearings 1 are fitted on the spindle 20 with an inner ring spacer 22 disposed therebetween. Each inner ring 2 has its front side fixed in position by an inner ring presser 23. The two outer rings 3 are mounted in the inner housing 21a with an outer ring spacer 24 disposed therebetween. The outer ring 3 have their front sides fixed in position by outer ring pressers 25, with cooling oil introducing members 11 which constitute the lubricator according to the present invention in abutment with the end surfaces thereof on the back sides thereof, respectively.

A cooling oil circulation passage 31 is defined between the inner and outer housings 21a and 21b of the bearing housing unit 21. Cooling oil is fed from the cooling oil feeder 30 into the cooling oil circulation passage 31 through a feed passage 32 and an inlet hole 34a formed in the radially outer surface of outer housing 21b, and returned to the feeder 30 through a discharge hole 34b formed in the radially outer surface of the outer housing 21b and a return passage 33.

Another feed passage 32a branches from the feed passage 32 of the cooling oil feeder 30 for feeding cooling oil to inlet holes 37 formed in both end surfaces of the inner housing 21a. In the branched feed passage 32a, a pressure regulating valve 35 and an oil filter 36 are provided. Cooling oil fed into the inlet holes 37 is then fed into the cooling oil introducing members 11 and used to lubricate the interiors of the angular ball bearings 1 and to cool their inner rings 2. Cooling oil is then collected into an oil collecting passage 38 formed in the lower portion of the inner housing 21a, and returned to the cooling oil feeder 30 by means of oil pumps 39.

As shown in FIG. 2, each oil introducing member 11, which is in abutment with the end surface of the outer ring 3 on the back side thereof, is fitted in the inner housing 21a, and is formed with an inlet hole 11b communicating with the inlet hole 37 of the inner housing 21a. At its end, the inlet hole 11b has a nozzle 12 through which cooling oil is discharged toward the circumferential groove 6 of the inner ring 2. The cooling oil introducing member 11 has an extension 11a protruding from its front end surface into the space between the inner ring 2 and the retainer 5. The extension 11a has a seal portion 13 that faces the tapered surface 2b of the inner ring 2 with a gap δ left therebetween. The extension 11a defines an oil storage space 14a around the circumferential groove 6. Most part of the cooling oil that has been discharged toward the circumferential groove 6 for cooling the inner ring 2 accumulates in the oil storage space 14a, and then flows through a communicating hole 11e formed in the cooling oil introducing member 11 into an oil storage space 14a sealed by a lid member 15 mounted to the rear end of the member 11.

Cooling oil that has been discharged toward the circumferential groove 6 to cool the inner ring 2 partially flows along the tapered surface 2b and through the gap between the tapered surface 2b and the seal portion 13 into the interior of the bearing as lubricating oil, under centrifugal force produced when the inner ring 2 rotates. The gap δ between inner surface of the seal portion 13 of the extension 11a and the tapered surface 2b of the inner ring 2 is set at 0.2 mm. In the radially inner surface of the extension 11a, two circumferential oil grooves 16 are formed to improve sealability, thereby stably suppressing the amount of cooling oil flowing into the interior of the bearing.

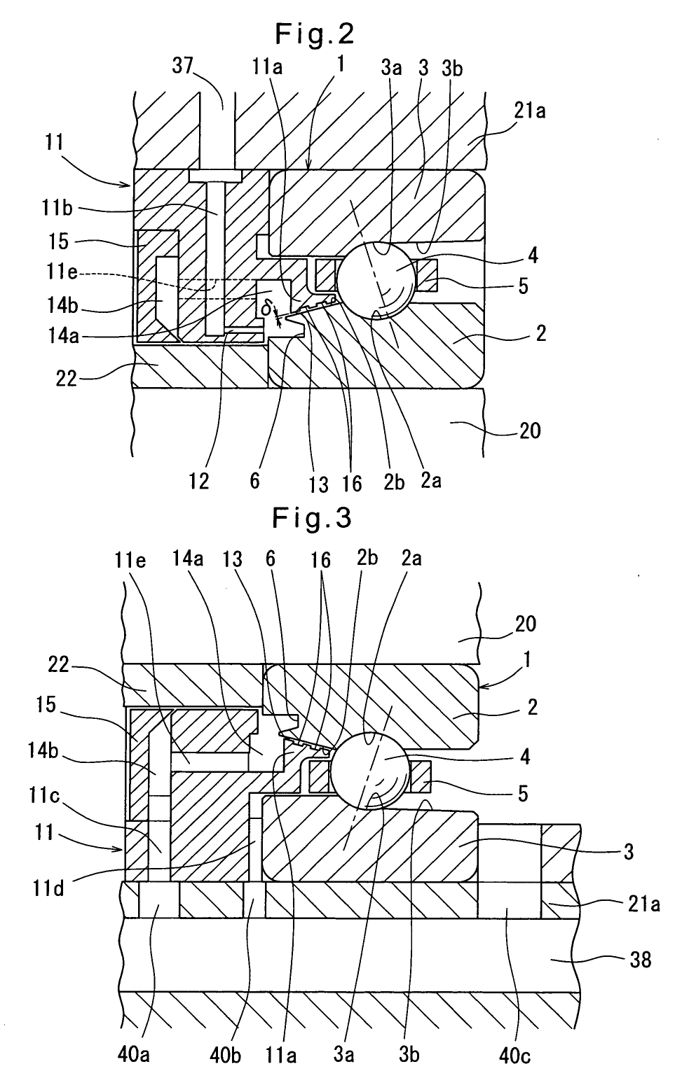

As shown in FIG. 3, the cooling oil introducing member 11 is formed with a discharge hole 11c communicating with the oil storage space 14b, and a discharge groove 11d extending along the end surface of the outer ring 3 and communicating with the interior of the bearing. In the lower portion of the inner housing 21a, discharge holes 40a and 40b are formed thorough which the discharge hole 11c and the discharge groove 11d communicate with the oil collecting passage 38, respectively. Thus, cooling oil that has cooled the inner ring 2 and accumulated in the oil storage space 14b is collected into the oil collecting passage 38 through the discharge holes 11c and 40a. Part of cooling oil that has lubricated the interior of the bearing is collected into the oil collecting passage 38 through the discharge groove 11d and the discharge hole 40b and also through a discharge hole 40c formed on the front side of the bearing.

### EXAMPLES

The amount Q of cooling oil discharged through the nozzle 12 and flowing through the seal portion 13 into the interior of the bearing as lubricating oil was measured when the gap δ of the seal portion 13 shown in FIG. 2 was changed. The diameter of the spindle 20 (inner diameter of the angular ball bearings 1) was 70 mm, its revolving speed was 30000 rpm, and the amount of cooling oil discharged through the nozzle 12 was 0.6 liters/minute.

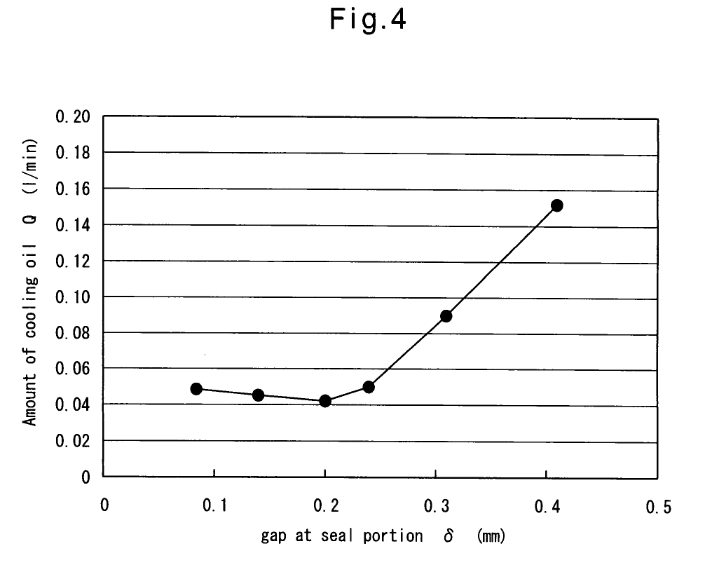

The results of measurement of the amount Q are shown in FIG. 4. As is apparent from these measurement results, while the gap δ is 0.2 mm or less, the amount Q was small and remained substantially unchanged. But when the gap δ exceeded 0.2 mm, the amount Q began to increase sharply. Thus, by setting the gap δ at the seal portion at 0.2 mm or less, it is possible to stably suppress the amount Q of cooling oil flowing into the interior of the bearing, thereby reducing the resistance of cooling oil when the oil is agitated during high-speed rotation of the bearing.

The temperature of the inner ring, which is being cooled by cooling oil, rises only to around 60° C. even while the bearing is rotating at a maximum speed of 55000 rpm, and the radial expansion at this time is about 0.09 mm. Thus, even while the rolling bearing is used at such high speed, by setting the gap δ at a value close to the upper limit of 0.2 mm, a gap is stably left that is large enough for cooling oil to be able to partially flow therethrough into the interior of the bearing.

In the embodiment, angular ball bearings are used as rolling bearings. But the lubricator for rolling bearings according to the present invention is also applicable to other rolling bearings such as deep groove ball bearings and roller bearings.

What is claimed is:

1. A lubricator for a rolling bearing, said lubricator being configured to discharge cooling oil supplied from a cooling oil feeder toward an inner rotary ring of the rolling bearing from one axial end of the bearing, and having a seal portion facing a radially outer surface of said inner ring at one end thereof toward which cooling oil is discharged, with a gap left between said seal portion and said radially outer surface of said inner ring, whereby the cooling oil discharged toward said one end of said inner ring partially flows through said gap into the interior of the bearing as lubricating oil, characterized in that said gap is not more than 0.2 mm.

2. A lubricator for a rolling bearing, said lubricator being configured to discharge cooling oil supplied from a cooling oil feeder toward an inner rotary ring of the rolling bearing from one axial end of the bearing, and having a seal portion facing a radially outer surface of said inner ring at one end thereof toward which cooling oil is discharged, with a gap left between said seal portion and said radially outer surface of said inner ring, whereby the cooling oil discharged toward said one end of said inner ring partially flows through said gap into the interior of the bearing as lubricating oil, characterized in that said seal portion is formed with a circumferential oil groove in a radially inner surface thereof that faces said radially outer surface of said inner ring.
